(19) United States
(12) Patent Application Publication
(10) Pub. No.: US 2018/0067444 A1
(43) Pub. Date: Mar. 8, 2018

(54) POWER CIRCUIT AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Takuya Ogishima, Izu Shizuoka (JP); Taku Yamabe, Mishima Shizuoka (JP); Toyoyasu Kusaka, Izu Shizuoka (JP)

(21) Appl. No.: 15/255,280

(22) Filed: Sep. 2, 2016

(51) Int. Cl. H03H 1/00; G03G 15/00; H02M 3/335

(52) U.S. Cl. CPC G03G 15/80; H02M 3/33507

(57) ABSTRACT

In accordance with an embodiment, a power circuit for supplying electric power to an image forming apparatus equipped with a drive system and a control system comprises a first power supply circuit configured to supply the electric power to the control system; a second power supply circuit configured to supply the electric power to the drive system; a first capacitor configured to smooth the electric power from a commercial power supply and to supply the smoothed electric power to the first power supply circuit; and a second capacitor having a larger capacity than the first capacitor and configured to smooth the electric power from the commercial power supply and to supply the smoothed electric power to the second power supply circuit.

### FIELD

Embodiments described herein relate generally to a power circuit and an image forming apparatus.

### BACKGROUND

An image forming apparatus executes a printing operation according to a print request. The image forming apparatus comprises a drive section such as a conveyance section that conveys a paper and an image forming section that forms an image on the paper and a control section that controls operations of the drive section. The image forming apparatus includes operation modes such as a normal mode of keeping the drive section in an operable state and a standby mode of stopping the drive section to keep only the operations of a control section.

A power supply unit used in the image forming apparatus full-wave rectifies input of a commercial power supply through a diode bridge. The power supply unit suppresses a harmonic current in such a manner that a power factor correction circuit operates to make a phase of an input voltage of the commercial power supply consistent with that of an input current thereof. Furthermore, the power supply unit supplies a direct current generated at a secondary side of a transformer to the drive section and the control section of the image forming apparatus when inputting output of the power factor correction circuit to a primary side of the transformer. The power supply unit supplies electric power to the drive section and the control section if the image forming apparatus operates in the normal mode. Further, the power supply unit supplies the electric power to the control section without supplying the electric power to the drive section if the image forming apparatus operates in a standby mode.

### DESCRIPTION OF THE DRAWINGS

FIG. 1 is a diagram illustrating an example of the configuration of an image forming apparatus according to an embodiment;

FIG. 2 is a diagram illustrating an example of the configuration of the image forming apparatus according to the embodiment;

FIG. 3 is a diagram illustrating an example of the configuration of a power circuit according to the embodiment; and

FIG. 4 is a diagram illustrating a state of the power circuit according to the embodiment.

### DETAILED DESCRIPTION

In accordance with an embodiment, a power circuit for supplying electric power to an image forming apparatus equipped with a drive system and a control system, comprises a first power supply circuit configured to supply the electric power to the control system; a second power supply circuit having a larger power supply capacity than the first power supply circuit and configured to supply the electric power to the drive system; a first capacitor configured to smooth the electric power from a commercial power supply and to supply the smoothed electric power to the first power supply circuit; and a second capacitor having a larger capacity than the first capacitor and configured to smooth the electric power from the commercial power supply and to supply the smoothed electric power to the second power supply circuit.

In accordance with an embodiment,

Hereinafter, the power circuit and an image forming apparatus according to an embodiment are described with reference to the accompanying drawings.

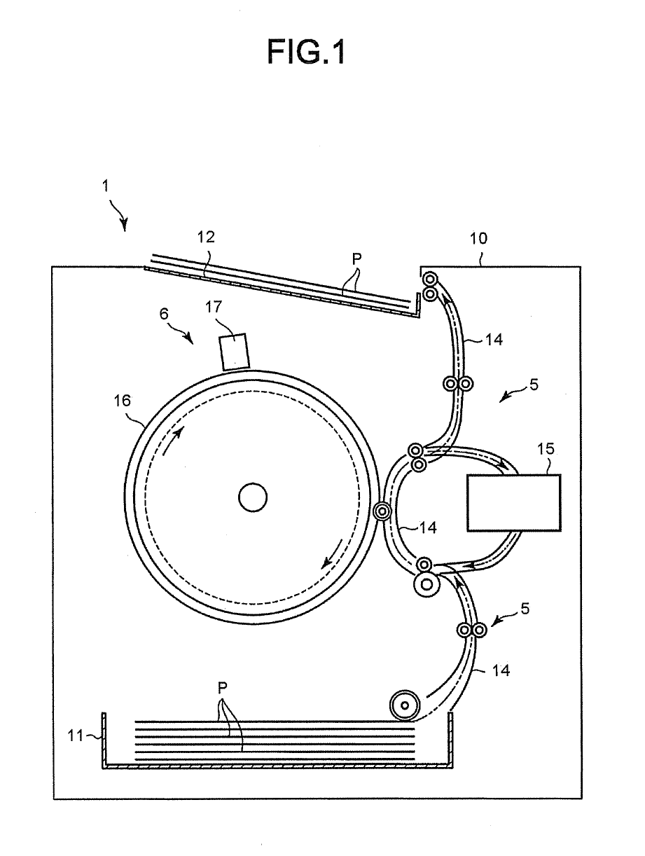

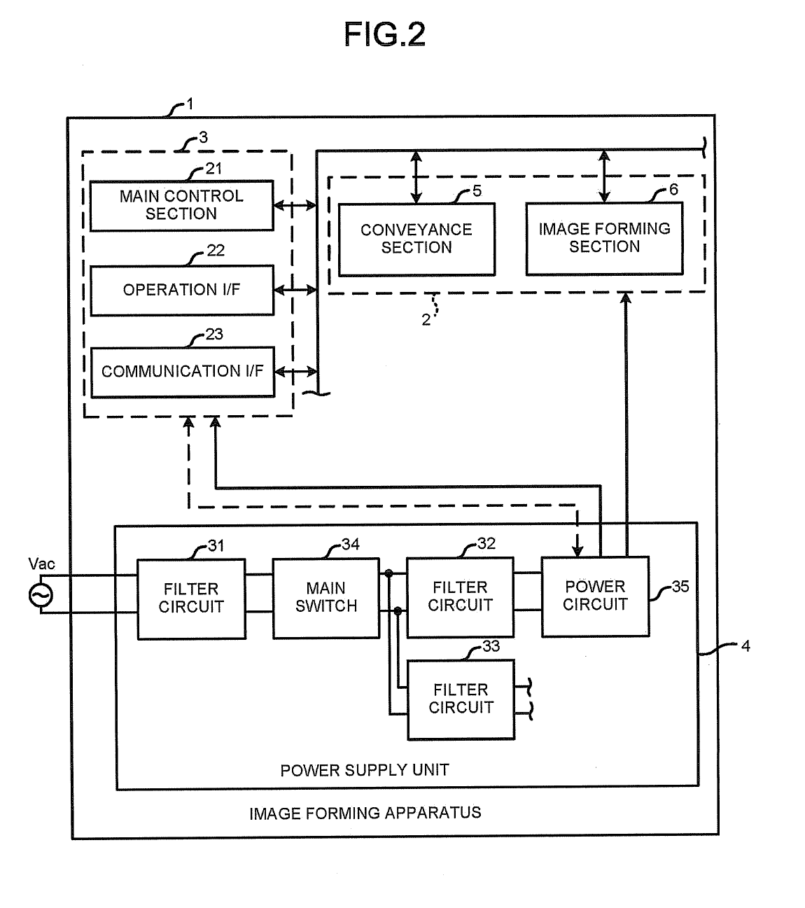

Firstly, the image forming apparatus 1 according to the embodiment is described. FIG. 1 and FIG. 2 are views illustrating examples of the configuration of the image forming apparatus according to the embodiment. FIG. 1 is a view illustrating an example of the configuration of a drive section of the image forming apparatus 1. FIG. 2 is a block diagram illustrating functions of the image forming apparatus as blocks.

The image forming apparatus 1 forms an image on an image receiving medium such as a paper with toner. The image forming apparatus 1, for example, conveys a recording paper P serving as the image receiving medium and carries out various processing such as an image forming processing and the like. The image forming apparatus 1 is, for example a laser printer, an inkjet printer or other printing devices. In the present embodiment, the image forming apparatus 1 is assumed as the laser printer to be described.

The image forming apparatus 1 is equipped with a drive system 2, a control system 3 and a power supply unit 4.

The drive system 2, the control system 3 and the power supply unit 4 are housed in a housing 10. A paper feed cassette 11 and a paper discharge tray 12 are arranged in the housing 10. The paper feed cassette 11 houses a plurality of the recording papers P. The paper discharge tray 12 houses the discharged recording paper P on which the image is formed by the image forming apparatus 1.

(About Drive System 2)

The drive system 2 conveys the recording paper P serving as the image receiving medium and carries out the image forming processing according to control of the control system 3. The drive system 2 is equipped with a conveyance section 5 and an image forming section 6.

The conveyance section 5 conveys the recording paper P. The conveyance section 5 is equipped with a conveyance path 14 composed of a plurality of guides and a plurality of conveyance rollers and a reversing device 15.

The conveyance path 14 includes a plurality of the guides and a plurality of the conveyance rollers arranged along a route in which the recording paper P is conveyed. The conveyance roller is driven by a motor that operates according to the control of the control system 3 to operate to convey the recording paper P. Part of a plurality of the guides rotates through a motor that operates according to the control of the control system 3 to switch the route for conveying the recording paper P. The conveyance section 5 conveys the recording paper P housed in the paper feed cassette 11 to the image forming section 6. Further, the conveyance section 5 conveys the recording paper P passing the image forming section 6 to the paper discharge tray 12. The conveyance section 5, for example, switches a conveyance destination to which the recording paper P is conveyed according to the control of the control system 3 between the paper discharge tray 12 and the reversing device 15.

The reversing device 15 reverses front surface and back surface and/or front and back of the recording paper P passing the image forming section 6 and supplies the reversed recording paper P to the image forming section 6 again.

The image forming section 6 forms a latent image corresponding to print data on a charged drum, enables the toner to adhere to the latent image and transfers the toner adhering to the latent image onto the recording paper P to form the image. The image forming section 6 is equipped with a drum 16 and a developing section 17.

The drum 16 is a photoconductive drum formed into a cylindrical shape. The drum 16 is arranged in such a way as to contact with the recording paper P conveyed in the conveyance path 14.

The developing section 17 charges the drum 16 and forms an electrostatic latent image on the charged drum 16. The developing section 17 enables the toner to adhere to the electrostatic latent image formed on the drum 16. In this way, the developing section 17 forms a toner image on the drum 16. The toner image formed on the drum 16 is transferred onto the recording paper P contacting with the drum 16. The toner image transferred onto the recording paper P is fixed by a roller for high temperature fixation (not shown). In this way, the image forming section 6 forms the image on the recording paper P conveyed in the conveyance path 14. The roller for fixation is heated by, for example, a heater such as a dump heater or an IH heater.

The image forming section 6, for example, may be arranged for each of different colors such as cyan, magenta, yellow and black.

(About Control System 3)

The control system 3 is equipped with a main control section 21, an operation I/F 22, and a communication I/F 23. The main control section 21 is equipped with a processor such as a CPU and a memory. The main control section 21 realizes various processing functions in such a manner that the processor executes a program stored in the memory. The operation I/F 22 is connected with an operation section (not shown). The operation I/F 22 supplies an operation signal corresponding to operation input to the operation section to the main control section 21. The communication I/F 23 is connected with a network or an electronic equipment (neither is shown). The communication I/F 23 can receive or send data from or to other electronic equipment directly or via the network. The communication I/F 23 is, for example, an LAN connector, an USB port, or a wireless LAN module.

The control system 3 controls the drive system 2, the power supply unit 4, and each section in the image forming apparatus 1. For example, the control system 3 controls conveyance of the recording paper P by the conveyance section 5 and formation of the image on the recording paper P by the image forming section 6.

For example, the main control section 21 acquires the print data via, for example, the communication I/F 23. The print data is constituted by arranging a plurality of lines composed of a plurality of pixels in parallel.

The main control section 21 controls an operation (for example, an operation of the motor for driving the conveyance roller and the guide) of the conveyance section 5 in response to the acquired print data. In this way, the main control section 21 conveys the recording paper P through the conveyance section 5.

Further, the main control section 21 controls an operation (for example, driving of the drum 16 and the developing section 17) of the image forming section 6 in response to the acquired print data. In this way, the main control section 21 forms the toner image through the image forming section 6 on the recording paper P conveyed by the conveyance section 5. The main control section 21 controls the conveyance section 5 to discharge the recording paper P on which the image corresponding to the print data is formed to the paper discharge tray 12.

For example, the control system 3 controls the power supply unit 4 to switch an operation mode of the image forming apparatus 1. The image forming apparatus 1 at least includes, for example, a normal mode serving as a state in which the drive system 2 and the control system 3 are operable and a standby mode serving as a state in which the control system 3 is operable and serving as a state in which the drive system 2 is stopped as the operation modes. For example, the control system 3 switches the operation mode from the normal mode to the standby mode if an operation and a print instruction are not input for a certain time in the normal mode. Further, the control system 3 switches the operation mode from the standby mode to the normal mode if a predetermined operation or print instruction is input in the standby mode. Further, for example, the control system 3 may switch the operation mode from the normal mode to the standby mode in response to any operation.

(About Power Supply Unit 4)

The power supply unit 4 supplies the electric power to each section of the image forming apparatus 1. The power supply unit 4 is equipped with a filter circuit 31, a filter circuit 32, a filter circuit 33, a main switch 34 and a power circuit 35. The filter circuit 31 is connected between a commercial power supply Vac and the main switch 34. The filter circuit 32 is connected between the main switch 34 and the power circuit 35. The filter circuit 33 is connected between the main switch 34 and a heater (not shown) for heating the roller for fixation. The power circuit 35 is connected with the drive system 2 and the control system 3 through an electric power supply line. Further, the power circuit 35 is connected with the control system 3 through a control line.

The filter circuit 31, the filter circuit 32 and the filter circuit 33 are circuits for reducing entering of external noise and discharge of noise to a commercial line.

The main switch 34 turns on/off input from the commercial power supply to the power supply unit 4.

The power circuit 35 rectifies the input from the commercial power supply Vac. The power circuit 35 improves power factor by a power factor correction circuit (for example, boosts) which inputs rectified direct voltage. The power circuit 35 converts (for example, steps down) to a rated direct voltage from output of the power factor correction circuit using the transformer. The power circuit 35 respectively supplies the step-down direct voltage to the drive system 2 and the control system 3.

A load of the drive system 2 is larger than that of the control system 3. For example, the power circuit 35 steps down an output voltage of the power factor correction circuit to a first voltage value (for example, 5 V) which corresponding to the control system 3, and supplies the electric power to the control system 3. Load capacity needs about 10 watts by the control system 3. Further, for example, the power circuit 35 steps down the output voltage of the power factor correction circuit to a second voltage value (for example, 24 V) which corresponds to the drive system 2 and is higher than the first voltage value, and supplies the electric power to the drive system 2. The load capacity needs about a hundred watts by the drive system 2. Further, the power circuit 35 may supply the electric power to other configurations in the image forming apparatus 1.

The power circuit 35 switches a state of supplying the electric power to both the drive system 2 and the control system 3 and a state of supplying the electric power to only the control system 3 without supplying the electric power to the drive system 2 from controlling of the control system 3 (input of an operation mode change signal). The operation mode change signal is used to change the state of the power circuit 35 in response to the operation mode of the image forming apparatus 1.

If the power circuit 35 supplies the electric power to both the drive system 2 and the control system 3, the image forming apparatus 1 becomes a state in which the drive system 2 and the control system 3 are operable. In other words, the state in which the power circuit 35 supplies the electric power to both the drive system 2 and the control system 3 corresponding to a state in which the operation mode of the image forming apparatus 1 is the normal mode. Further, if the power circuit 35 supplies the electric power to only the control system 3 without supplying the electric power to the drive system 2, the image forming apparatus 1 becomes a state in which the control system 3 is operable and the drive system 2 does not function. In other words, the state in which the power circuit 35 does not supply the electric power to the drive system 2 but supplies the electric power to the control system 3 corresponding to a state in which the operation mode of the image forming apparatus 1 is the standby mode. In other words, the operation mode of the image forming apparatus 1 is switched with the state of the power circuit 35.

(About Power Circuit 35)

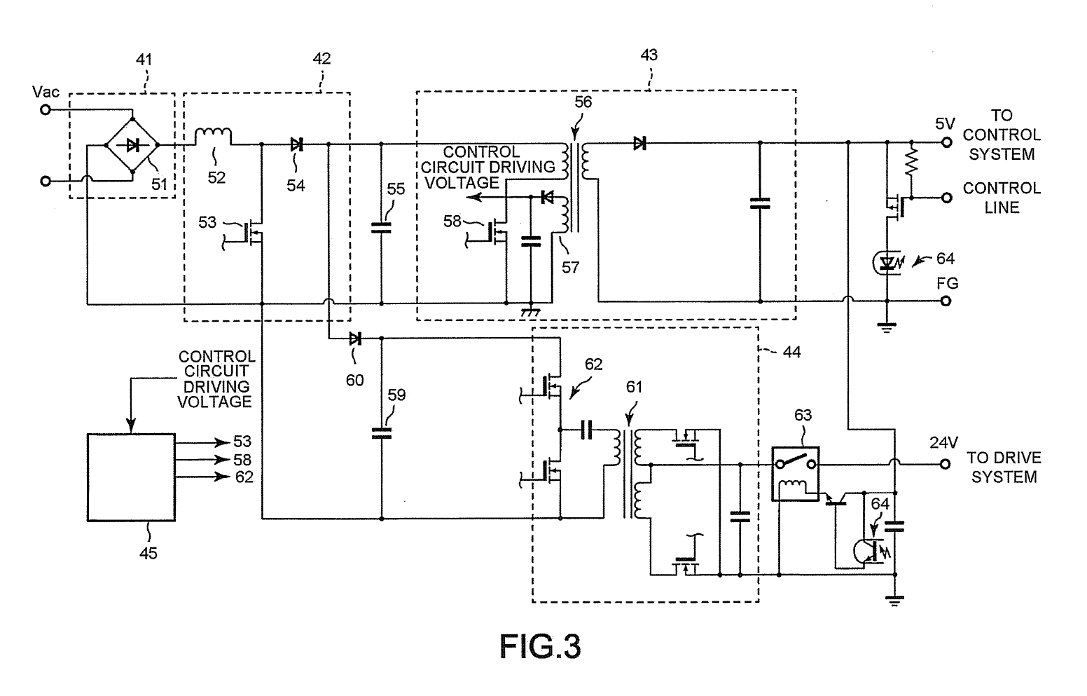

FIG. 3 is a view illustrating an example of the configuration of the power circuit 35. The power circuit 35 is equipped with a rectification circuit 41, the power factor correction circuit 42, a first power supply circuit 43, a second power supply circuit 44 and a control circuit 45. The power circuit 35 generates the direct voltage by full-wave rectification of alternating current power input via the filter 32. The power circuit 35 outputs high-voltage direct voltage by the power factor correction circuit 42 operation.

The power circuit 35 steps down the output voltage of the power factor correction circuit 42 through the first power supply circuit 43 and the second power supply circuit 44 which are parallelly connected with the output side of the power factor correction circuit 42. The power circuit steps down the output voltage of the power factor correction circuit 42 to the direct voltage at the first voltage value corresponding to the control system 3 to supply the direct voltage to the control system 3 through the first power supply circuit 43. Further, the power circuit 35 steps down the output voltage of the power factor correction circuit 42 to the direct voltage at the second voltage value corresponding to the drive system 2 to supply the direct voltage to the drive system 2 through the second power supply circuit 44.

The rectification circuit 41 is equipped with a rectifier bridge 51 composed of, for example, a diode bridge element. A pair of input terminals of the rectifier bridge 51 is connected with the commercial power supply Vac via the filter circuits 31 and 32 and the main switch 34 shown in FIG. 2. The rectification circuit 41 converts an alternating voltage supplied from the commercial power supply Vac to the direct voltage through the rectifier bridge 51. The rectification circuit 41 outputs the direct voltage from a pair of output terminals of the rectifier bridge 51.

The power factor correction circuit 42 is connected with the output side of the rectification circuit 41. The power factor correction circuit 42 is equipped with a coil 52, a first switching element 53, and a diode 54, functioning as, for example, a boosting chopper. The power factor correction circuit 42 boosts the output voltage of the rectification circuit 41 and outputs the boosted voltage according to on-off control of the first switching element 53.

A first capacitor 55 is connected with the output terminal of the power factor correction circuit 42. The first capacitor 55 smooths the output of the power factor correction circuit 42 and outputs the smoothed output to a circuit of a posterior stage.

The first power supply circuit 43 is connected with the posterior stage of the first capacitor 55. The first power supply circuit 43 functions as, for example, a flyback topology. The first power supply circuit 43 is equipped with, for example, a first transformer 56, a VCC winding 57, and a second switching element 58. The first power supply circuit 43 outputs the electric power from the secondary side of transformer 56 according to the on-off control of the second switching element 58 connected with the first transformer 56. Furthermore, the first power supply circuit 43 steps down the direct voltage input to the primary side of the first transformer 56 and outputs the electric power from the secondary side. The control system 3 is connected with the output side of the first power supply circuit 43. In other words, the first power supply circuit 43 steps down the output voltage of the power factor correction circuit 42 to the direct voltage at the first voltage value corresponding to the control system 3 and supplies the step-down output voltage to the control system 3.

The VCC winding 57 is coupled to the first transformer 56 according to the on-off control of the second switching element 58. Thus, a voltage is generated in the VCC winding 57. The generated voltage in the VCC winding 57 is smoothed by a capacitor to be supplied to the control circuit 45 as a control circuit driving voltage.

A second capacitor 59 is connected with the output terminal of the power factor correction circuit 42, which is parallel to the first capacitor 55. The second capacitor smooths the output of the power factor correction circuit 42 and outputs the smoothed output to a circuit of a posterior stage.

A diode 60, as a rectifying element for rectifying a current from the output terminal of the power factor correction circuit 42 to the second capacitor 59, is connected between the output terminal of the power factor correction circuit 42 and the second capacitor 59. The diode 60 prevents a flow of electric charge of the second capacitor 59 into the first power supply circuit 43 (or the first capacitor 55). In other words, the diode 60 suppresses the flow of the current from the second capacitor 59 to the first capacitor 55 or the first power supply circuit 43.

The second power supply circuit 44 is connected with the posterior stage of the second capacitor 59. The second power supply circuit 44 functions as, for example, a resonance-type power supply circuit. The second power supply circuit 44 is equipped with, for example, a second transformer 61, a totem pole FETs 62, two FETs for rectification, and the capacitor.

The totem pole FETs 62 is composed of two N-channel FETs. If the totem pole FETs 62 is turned on/off, resonance phenomenon generated by leakage inductance of the second transformer 61 and resonance capacitor, then the second transformer 61 coupled with primary side and the secondary side. In this way, the second power supply circuit 44 outputs the electric power from the secondary side with the stepped down direct voltage. The drive system 2 is connected with the output side of the second power supply circuit 44. The output voltage of the secondary side of the second transformer 61 is rectified by the synchronous two FETs and smoothed by the capacitor to be supplied from the second power supply circuit 44 to the drive system 2. In other words, the second power supply circuit 44 steps down the output voltage of the power factor correction circuit to the direct voltage at the second voltage value corresponding to the drive system 2 and supplies the step-down output voltage.

A relay switch 63 is connected between the second power supply circuit 44 and the drive system 2. The relay switch 63 connects with the second power supply circuit 44 and the drive system 2 if the relay switch 63 is turned on, and disconnects if the relay switch 63 is turned off. In other words, the second power supply circuit 44 supplies a drive voltage to the drive system 2 if the relay switch 63 is turned on.

On-off of the relay switch 63 is controlled through a signal (operation mode change signal) from the control system 3 of the image forming apparatus 1. For example, if the operation mode change signal is input from the control system 3, anode and cathode of a photo coupler 64 connected with the control system 3 via the control line, and an emitter and a collector of the photo coupler 64 are conducted. If the emitter and the collector of the photo coupler 64 are conducted, the coil of the relay switch 63 is excited and turned on.

The control circuit 45 controls the on-off control of the first switching element 53, the second switching element 58, and the totem pole FETs 62. The control circuit 45 controls—the first switching element 53 to adjust the output voltage of the power factor correction circuit 42. The control circuit 45 controls the second switching element 58 to adjust the output voltage of the first power supply circuit 43. Further, the control circuit 45 controls the totem pole FETs 62 to adjust the output voltage of the second power supply circuit 44.

The control circuit 45 controls the first switching element 53, the second switching element 58, and the totem pole FETs 62 according to the control circuit driving voltage generated in the VCC winding 57 as stated above. If the control circuit driving voltage generated in the VCC winding 57 is higher than an oscillation continuation voltage set in the first power supply circuit 43, the on/off control of the second switching element 58 is continued. In this case, transformer coupling is generated at the primary side and the secondary side of the first transformer 56, the voltage applied to the primary side is stepped down, and the electric power is supplied from the secondary side to the control system 3. On the other hand, if the control circuit driving voltage generated in the VCC winding 57 is lower than the oscillation continuation voltage set in the first power supply circuit 43, the on/off control of the second switching element 58 is discontinued. In this case, no transformer coupling is generated at the primary side and the secondary side of the first transformer 56, and the image forming apparatus 1 becomes a state in which the electric power is not supplied from the secondary side to the control system 3. As a result, the image forming apparatus 1 becomes a switch-off state in which the operations of the control system 3 and the drive system 2 are stopped.

(About First Capacitor 55, and Second Capacitor 59)

As stated above, the second capacitor 59 supplies the electric power to the second power supply circuit 44. The second power supply circuit 44 supplies the electric power to the drive system 2. The drive system 2 includes the conveyance section 5 and the image forming section 6, and required power supply capacity thereof is larger than that of the control system 3. For example, the drive system 2 is constituted with rated output 300 W.

The first capacitor 55 supplies the electric power to the first power supply circuit 43. The first power supply circuit 43 supplies the electric power to the control system 3. The control system 3 is used for control of a system of the image forming apparatus 1, and thus the required power supply capacity thereof is smaller than that of the drive system 2. For example, the control system 3 is constituted with rated output 10 W.

Capacitors of the first capacitor 55 and the second capacitor 59 are determined according to the required power supply capacity (maximum output capacity). For example, the second capacitor 59 that supplies the electric power to the drive system 2 is constituted with 330 pF (microfarad). Furthermore, the first capacitor 55 that supplies the electric power to the control system 3 is constituted with 22 pF (microfarad).

The first power supply circuit 43 serving as a power supply for the control system 3 continuously supplies a direct current of 5 V to the control system 3 regardless of the operation mode of the image forming apparatus 1. The first power supply circuit 43 continuously supplies the direct current of 5 V until the VCC winding 57 is smaller than the oscillation continuation voltage set in the first power supply circuit 43.

The capacity of the first capacitor 55 that supplies the electric power to the control system 3 with the small required power supply capacity is smaller than that of the second capacitor 59 that supplies the electric power to the drive system 2 with large required power supply capacity. Through such a configuration, the power circuit 35 in the present invention can shorten time for supplying the electric power to the control system 3 if the main switch 34 is turned off. In other words, the power circuit 35 in the present invention can shorten time until the operations of the image forming apparatus 1 are completely stopped after the main switch 34 is turned off.

On the contrary, the second power supply circuit 44 serving as a power supply for the drive system 2 switches a state of supplying the electric power to the drive system 2 and a state of not supplying the electric power thereto according to the operation mode of the image forming apparatus 1. The switch between the state of supplying the electric power to the drive system 2 and the state of not supplying the electric power thereto is carried out by the relay switch 63 of which the on-off is controlled according to the operation mode change signal from the control system 3 as stated above. In other words, the second power supply circuit 44 is constituted an output range from no-load to 300 W.

In the foregoing configuration, if the relay switch 63 is turned off and the second power supply circuit 44 is turned off, the electric charge in the second capacitor 59 is not discharged. However, the diode 60, as the rectifying element for rectifying the current in a direction from the output terminal of the power factor correction circuit 42 to the second capacitor 59, is connected between the second capacitor 59 and the output terminal of the power factor correction circuit 42. In this way, the power circuit 35 in the present invention can prevent the flowing of the electric charge of the second capacitor 59 to the first power circuit 43 if the main switch 34 is turned off. As a result, the power circuit 35 in the present invention can shorten the time until the operations of the image forming apparatus 1 are completely stopped after the main switch 34 is turned off.

Further, the diode 60 is exemplified as the rectifying element for rectifying the current in a direction from the output terminal of the power factor correction circuit 42 to the second capacitor 59; however, the configuration of the rectifying element is not limited to this. The rectifying element may be a switching element such as the on-off switchable relay switch, a P-channel FET, a thyristor and the like.

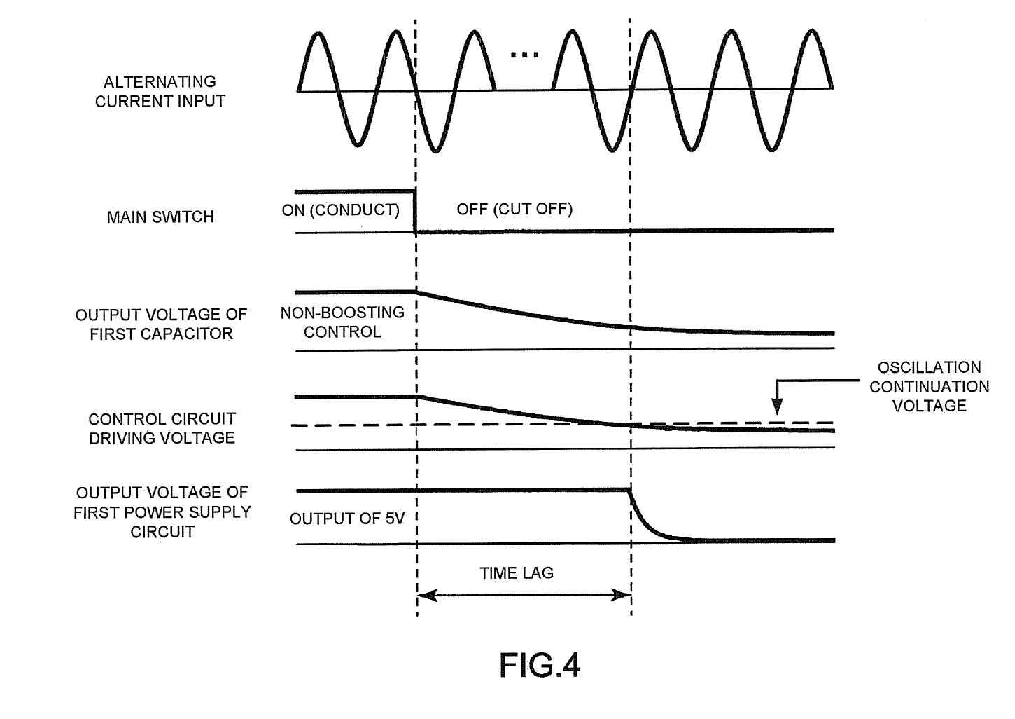

FIG. 4 is a diagram illustrating an example of the behavior of the power circuit 35 in a case in which the main switch 34 is turned off if the operation mode of the image forming apparatus 1 is the standby mode.

If the operation mode of the image forming apparatus 1 is the standby mode and the main switch 34 is turned on, the switching of the power factor correction circuit 42 does not work and the boosting is not carried out. In this case, since an electric charge is stored in the first capacitor 55, the first capacitor 55 discharges a direct voltage. Further, the control circuit driving voltage is also generated at a predetermined voltage value. As a result, the first power supply circuit 43 supplies the direct voltage at the first voltage value (for example, 5 V) to the control system 3 according to the electric charge in the first capacitor 55.

If the operation mode of the image forming apparatus 1 is the standby mode and the main switch 34 is turned off, the supply of the electric power from the commercial power supply Vac is cut off. In this case, according to the electric charge left in the first capacitor 55, the gradually decreased direct voltage is supplied to the first power supply circuit 43. In the first power supply circuit 43, the switching of the second switching element 58 connected with the first transformer 56 is continued until the voltage value of the control circuit driving voltage is smaller than a predetermined value (oscillation continuation voltage). Thus, the first power supply circuit 43 supplies the direct voltage at the first voltage value (for example, 5 V) to the control system 3 until the voltage value of the control circuit driving voltage is smaller than the predetermined value (oscillation continuation voltage). If the voltage value of the control circuit driving voltage is smaller than the oscillation continuation voltage, the switching of the second switching element 58 connected with the first transformer 56 is stopped. In this way, the transformer coupling at the primary side and the secondary side of the first transformer 56 is released, and the voltage from the secondary side of the first transformer 56 is not output. As a result, the power supply of the image forming apparatus 1 is completely turned off.

In this way, a time between the main switch 34 is turned off to the power supply of the image forming apparatus 1 is completely turned off is determined depending on the capacity of the first capacitor 55 that supplies the electric power to the first power supply circuit 43. Through the configuration in the present invention, the capacity of the first capacitor 55 that supplies the electric power to the control system 3 is smaller than that of the second capacitor 59 that supplies the electric power to the drive system 2 with the higher power supply capacity. Thus, the power circuit 35 in the present invention can shorten the time between the main switch 34 is turned off to the power supply of the image forming apparatus 1 is completely turned off.

Other than in the operating examples, or where otherwise indicated, all numbers, values and/or expressions referring to quantities of ingredients, reaction conditions, etc., used in the specification and claims are to be understood as modified in all instances by the term “about.”

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A power circuit for supplying electric power to an image forming apparatus, comprising:
a first power supply circuit configured to supply the electric power to a control system of the image forming apparatus;
a second power supply circuit having a larger power supply capacity than the first power supply circuit and configured to supply the electric power to a drive system of the image forming apparatus which conveys paper;
a first capacitor configured to smooth the electric power from a commercial power supply and to supply the smoothed electric power to the first power supply circuit; and
a second capacitor having a larger capacity than the first capacitor and configured to smooth the electric power from the commercial power supply and to supply the smoothed electric power to the second power supply circuit.

2. The power circuit according to claim 1, further comprising
a switch configured to switch a state in which the first power supply circuit supplies the electric power to the control system and the second power supply circuit supplies the electric power to the drive system and a state in which the first power supply circuit supplies the electric power to the control system and the second power supply circuit does not supply the electric power to the drive system.

3. The power circuit according to claim 1, wherein
the capacity of the first capacitor is determined according to the power supply capacity of the first power supply circuit; and
the capacity of the second capacitor is determined according to the power supply capacity of the second power supply circuit.

4. The power circuit according to claim 1, further comprising
a rectifying element configured to suppress flow of a current from the second capacitor to the first capacitor or to the first power supply circuit.

5. (canceled)

6. The power circuit according to claim 1, wherein the first power supply circuit steps down output voltage of a power factor correction circuit and supplies the step-down output to the control system.

7. The power circuit according to claim 1, wherein the second power supply circuit steps down output voltage of a power factor correction circuit and supplies the step-down output to the drive system.

8. An image forming apparatus, comprising:
a drive system configured to convey a paper;
a control system configured to control the drive system;
a first power supply circuit configured to supply electric power to the control system;
a second power supply circuit having a larger power supply capacity than the first power supply circuit and configured to supply the electric power to the drive system;
a first capacitor configured to smooth electric power from a commercial power supply and to supply the smoothed electric power to the first power supply circuit; and
a second capacitor having a larger capacity than the first capacitor and configured to smooth the electric power from the commercial power supply and to supply the smoothed electric power to the second power supply circuit.

9. The image forming apparatus according to claim 8, further comprising
a switch configured to switch a state in which the first power supply circuit supplies the electric power to the control system and the second power supply circuit supplies the electric power to the drive system and a state in which the first power supply circuit supplies the electric power to the control system and the second power supply circuit does not supply the electric power to the drive system.

10. The image forming apparatus according to claim 8, wherein
the capacity of the first capacitor is determined according to the power supply capacity of the first power supply circuit; and
the capacity of the second capacitor is determined according to the power supply capacity of the second power supply circuit.

11. The image forming apparatus according to claim 8, further comprising
a rectifying element configured to suppress flow of a current from the second capacitor to the first capacitor or to the first power supply circuit.

12. (canceled)

13. The image forming apparatus according to claim 8, wherein the first power supply circuit steps down output voltage of a power factor correction circuit and supplies the step-down output to the control system.

14. The image forming apparatus according to claim 8, wherein the second power supply circuit steps down output voltage of a power factor correction circuit and supplies the step-down output to the drive system.

15. A method of operating an image forming apparatus
a power circuit for supplying electric power to an image forming apparatus, comprising:
supplying electric power to a control system of the image forming apparatus from a first power supply circuit;
supplying electric power to a drive system of the image forming apparatus which conveys a paper from a second power supply circuit having a larger power supply capacity than the first power supply circuit;
smoothing electric power from a commercial power supply and supplying the smoothed electric power to the first power supply circuit from a first capacitor; and
smoothing electric power from the commercial power supply and supplying the smoothed electric power to the second power supply circuit from a second capacitor having a larger capacity than the first capacitor.

16. The method according to claim 15, further comprising
switching a state in which the first power supply circuit supplies the electric power to the control system and the second power supply circuit supplies the electric power to the drive system and a state in which the first power supply circuit supplies the electric power to the control system and the second power supply circuit does not supply the electric power to the drive system.

17. The method according to claim 15, further comprising suppressing flow of a current from the second capacitor to the first capacitor or to the first power supply circuit.
